(19) United States
(12) Patent Application Publication
(10) Pub. No.: US 2025/0225610 A1
(43) Pub. Date: Jul. 10, 2025

(54) RAW IMAGE DATA RECONSTRUCTION SYSTEM AND METHOD

(71) Applicant: DOLBY LABORATORIES LICENSING CORPORATION

(72) Inventors: Dongdong FU, Cupertino, CA (US); Tao CHEN, Palo Alto, CA (US)

(73) Assignee: DOLBY LABORATORIES LICENSING CORPORATION, (US)

(21) Appl. No.: 18/853,411

(22) PCT Filed: Mar. 31, 2023
(86) PCT No.: PCT/US2023/017135

§ 371 Date: Oct. 1, 2024

Related U.S. Application Data
(60) Provisional application No. 63/326,987, filed on Apr. 4, 2022.

(30) Foreign Application Priority Data
Apr. 4, 2022 (EP) 22166487.3

(51) Int. Cl. G06T 3/4007; G06T 5/70

(52) U.S. Cl. CPC G06T 3/4007; G06T 5/70; G06T 2207/20024

(57) ABSTRACT

A method for reconstructing a raw image, including: generating a low-frequency image and a high-frequency image from an initial image; linearly estimating the high-frequency image to generate a reconstructed high-frequency image; sparsely interpolating the low-frequency image to generate a reconstructed low-frequency image; and generating a reconstructed raw image from the reconstructed low-frequency image and the reconstructed high-frequency image.

### CROSS-REFERENCE TO RELATED APPLICATIONS

This application claims the benefit of priority to European patent application 22 166 487.3 (reference: D21137EP), and U.S. Provisional patent application Ser. No. 63/326,987 (reference: D21137USP1), both filed on 4 Apr. 2022, each of which is incorporated by reference in its entirety.

### BACKGROUND

Many consumer electronics products include at least one camera. These products include tablet computers, mobile phones, and smart watches. In such products, and in digital still cameras themselves, the cameras include an image sensor having many pixels arranged as a pixel array. The image sensor, an image signal processor (ISP), or an image editing tool may adjust a captured raw image to more accurately depict an image that resembles that seen by a human eye. Many of the operations performed by the ISP or editing tool are non-linear and even spatially varying and require intensive computing power to reverse, if possible at all. As appreciated by the inventors, improved techniques for raw image reconstruction are desired.

Mahmoud Afifi: “Image color correction, enhancement, and editing”, Arxiv.org, Cornell University Library, NY 14853, 28 Jul. 2021, XP091018402, discloses methods and approaches to image color correction, color enhancement, and color editing. The color correction problem is studied from the standpoint of the camera's image signal processor (ISP). A camera's ISP is hardware that applies a series of in-camera image processing and color manipulation steps, many of which are nonlinear in nature, to render the initial sensor image to its final photo-finished representation saved in the 8-bit standard RGB (sRGB) color space. As white balance (WB) is one of the major procedures applied by the ISP for color correction, two different methods for ISP white balancing are presented. Another scenario of correcting and editing image colors is discussed, where a set of methods are presented to correct and edit WB settings for images that have been improperly white-balanced by the ISP. Then, another factor is explored that has a significant impact on the quality of camera-rendered colors, in which two different methods are outlined to correct exposure errors in camera-rendered images. Lastly, post-capture auto color editing and manipulation are discussed. In particular, auto image recoloring methods are proposed to generate different realistic versions of the same camera-rendered image with new colors.

Abhijith Punnappurath et al.: “Spatially Aware Metadata for Raw Reconstruction”, 2021 IEEE Winter Conference on Applications of Computer Vision (WACV), IEEE, 3 Jan. 2021, pages 218-226, XP033926466, discloses a spatially aware metadata-based raw reconstruction method. A camera sensor captures a raw-RGB image that is then processed to a standard RGB (sRGB) image through a series of onboard operations performed by the camera's image signal processor (ISP). Among these processing steps, local tone mapping is one of the most important operations used to enhance the overall appearance of the final rendered sRGB image. For certain applications, it is often desirable to de-render or unprocess the sRGB image back to its original raw-RGB values. This “raw reconstruction” is a challenging task because many of the operations performed by the ISP, including local tone mapping, are nonlinear and difficult to invert. Existing raw reconstruction methods that store specialized metadata at capture time to enable raw recovery ignore local tone mapping and assume that a global transformation exists between the raw-RGB and sRGB color spaces. The disclosed spatially aware metadata-based raw reconstruction method is robust to local tone mapping and yields significantly higher raw reconstruction accuracy (6 dB average PSNR improvement) compared to existing raw reconstruction methods. The disclosed method requires only 0.2% samples of the full-sized image as metadata, has negligible computational overhead at capture time, and can be easily integrated into modern ISPs.

Nguyen Rang et al.: “RAW Image Reconstruction Using a Self-Contained SRGB-JPEG Image with Only 64 KB Overhead”, 2016 IEEE Conference on Computer Vision and Pattern Recognition (CVPR), IEEE, 27 Jun. 2016, pages 1655-1663, XP033021343, discloses a method for reconstructing a RAW image from an sRGB-JPEG image. Most camera images are saved as 8-bit standard RGB (sRGB) compressed JPEGs. Even when JPEG compression is set to its highest quality, the encoded sRGB image has been significantly processed in terms of color and tone manipulation. This makes sRGB-JPEG images undesirable for many computer vision tasks that assume a direct relationship between pixel values and incoming light. For such applications, the RAW image format is preferred, as RAW represents a minimally processed, sensor-specific RGB image with higher dynamic range that is linear with respect to scene radiance. The drawback with RAW images, however, is that they require large amounts of storage and are not well-supported by many imaging applications. To address this issue, a method is presented to encode the necessary metadata within an sRGB image to reconstruct a high-quality RAW image. The disclosed approach requires no calibration of the camera and can reconstruct the original RAW to within 0.3% error with only a 64 KB overhead for the additional data. More importantly, the output is a fully self-contained 100% complainant sRGB-JPEG file that can be used as-is, not affecting any existing image workflow—the RAW image can be extracted when needed, or ignored otherwise.

### SUMMARY

The invention is defined by the independent claims. The dependent claims concern optional features of some embodiments. According to an embodiment, a method for reconstructing raw image data, including generating a low-frequency image and a high-frequency image from an initial image; linearly estimating the high-frequency image to generate a reconstructed high-frequency image; sparsely interpolating the low-frequency image to generate a reconstructed low-frequency image; and generating a reconstructed raw image from the reconstructed low-frequency image and the reconstructed high-frequency image.

According to an embodiment, a method for generating an image-reconstruction metadata set, including generating a raw low-frequency image and a raw high-frequency image from a raw image or an image derived therefrom using decomposition parameters; subsampling the raw low-frequency image to generate sub-sampled data; filtering a rendered image using the decomposition parameters to yield a high-frequency image, the rendered image having been derived from the raw image; determining a reconstruction matrix, a product of the reconstruction matrix, and the high-frequency image equaling the raw high-frequency image.

According to an embodiment, a method for reconstructing an image, including generating sub-sampled data and reconstruction matrix by generating a raw low-frequency image and a raw high-frequency image from a raw image or an image derived therefrom using decomposition parameters, subsampling the raw low-frequency image to generate sub-sampled data, and filtering a rendered image using the decomposition parameters to yield a high-frequency image, the rendered image having been derived from the raw image; and determining a reconstruction matrix, wherein a product of the reconstruction matrix and the high-frequency image equals the raw high-frequency image; sparsely interpolating a low-frequency image to generate a reconstructed low-frequency image using the sub-sampled data; linearly estimating the raw high-frequency image that yields the high-frequency image multiplied by a reconstruction matrix; and generating a reconstructed raw image from the reconstructed low-frequency image and the reconstructed high-frequency image.

According to an embodiment, a system includes: a processor; a memory communicatively coupled with the processor and storing machine-readable instructions that, when executed by the processor, cause the processor to: generate a low-frequency image and a high-frequency image from an initial image; linearly estimate the high-frequency image to generate a reconstructed high-frequency image; sparsely interpolate the low-frequency image to generate a reconstructed low-frequency image; and generate a reconstructed raw image from the reconstructed low-frequency image and the reconstructed high-frequency image.

### BRIEF DESCRIPTION OF THE FIGURES

FIG. 1 depicts a camera imaging a scene having a high dynamic range of luminance, according to embodiments.

FIG. 2 is a flow diagram illustrating a camera transmitting a rendered image from FIG. 1, along with generated reconstruction metadata, to other electronic devices, according to embodiments.

FIG. 3 is a flow diagram illustrating a process for reconstructing a raw image using a rendered image and generated reconstruction metadata, according to embodiments.

FIG. 4 is a schematic block diagram of a reconstruction metadata generator that generates an image-reconstruction metadata set, according to embodiments.

FIG. 5 is a schematic of a raw image-data reconstructor that reconstructs a raw image from a rendered image using the image-reconstruction metadata set of FIG. 4, according to embodiments.

FIG. 6 is a flowchart illustrating a method for reconstructing a raw image from an initial image, according to embodiments.

FIG. 7 is a flowchart illustrating a method for generating an image-reconstruction metadata set, according to embodiments.

FIG. 8 is a schematic of a raw image-data reconstructor that includes the reconstruction metadata generator of FIG. 4 and the raw image-data reconstructor of FIG. 5, according to embodiments.

FIG. 9 is a flowchart illustrating a method for reconstructing a raw image from a rendered image and reconstruction metadata.

### DETAILED DESCRIPTION OF THE EMBODIMENTS

In modern digital cameras and smart devices (e.g., smart phones), image sensors capture and convert a captured real scene into the camera's raw-RGB signals, which are also called scene-referred data. An image signal processor (ISP) (hereinafter used interchangeably with “processor” and “processor”) processes the raw-RGB signals (hereinafter used interchangeably with “raw image”) to obtain final output signals which are typically called display-referred (used interchangeably with “rendered image” and “initial image”) and may be in standard color spaces, such as sRGB, P3, Bt2020, etc. The final output signals are typically compressed (but may be uncompressed) and stored in some standard image or video file format, such as JPEG, MPEG, AVC, HEVC, etc.

To turn the raw-RGB signals into a realistic scene (e.g., mimicking what a person may view as depicted by the human eye), ISPs usually perform a series of compute-intensive image operations, such as black-level correction, lens-shading correction, white balancing, color correction, global/local tone mapping, denoising, sharpening, and/or other forms of image or video enhancement operations. Camera ISPs are typically proprietary and have different parameters for tuning preferences established from different camera manufacturers. Therefore, a camera capturing a same scene with the same field-of-view, may output images/videos with sometimes completely different perception in color, contrast, sharpness, noise, details and so on, than other cameras. Some ISP operations are non-linear and even spatially varying, which is difficult to reverse to reconstruct the raw-RGB signals. But in some applications, it is desirable to reverse the ISP's processing back to the raw signal domain. For example, digital cameras are typically tuned for a visually pleasing or aesthetic purpose, which might exaggerate color saturation and enhance memory color enhancement. To achieve precise color reproduction of the scene-referred image/data, it is very important to remove extra ISP photo-finishing operations, such as saturation enhancement, selective color enhancement, and so on. Another example is that sometimes a user may need to have consistent scene-referred image/data even when a real-scene is captured from a different electronic device. Once the user has the camera raw image, they may re-render the raw image according to their preference to guarantee consistent output.

Additional applications include image operations that operate in linear space, such as color/white balance post-correction. Cameras typically use an in-camera auto-white-balancing (AWB) algorithm to estimate the scene illuminance at the capture time. But the AWB algorithm does not always result in a correct estimation of scene illuminance and therefore may apply incorrect white balance gains on the raw image, causing unpleasing color cast on the final output image. Though post-correcting these color errors is straightforward in linear raw-image domain, it is very difficult to correct them in final output image domain because of the non-linear and spatial variable operations required for the final output.

Camera raw-image reconstruction may also find important use cases in recent deep learning training data augmentation and expansion, which usually needs to simulate the same scene under different illuminations and different image operations. Most simulations need to work in linear raw space for improved results. Even though users may save the raw images with the final output (e.g., JPEG/HEIC images) at the capture time for later processing, the large size of raw images is typically prohibitive for storage and communications. Therefore, to reverse the ISP rendering and reconstructing the scene-referred image/data directly from the output image/video, generating information (reconstruction metadata) when performing operations during rendering (e.g., a small size of data) is of great importance for not only in-camera image/video processing and offline image/video processing/editing tools, but also for image/video storage and communications. The present embodiments discuss a JPEG image in sRGB space, however, these are used for illustration purposes. Present embodiments work in any color space and any existing image/video file formats. For example, it may be used for iPhones, which have output HEIC image in P3 color space. Moreover, it may also be extended to R. 2020 PQ or HLG in the case of HDR capturing.

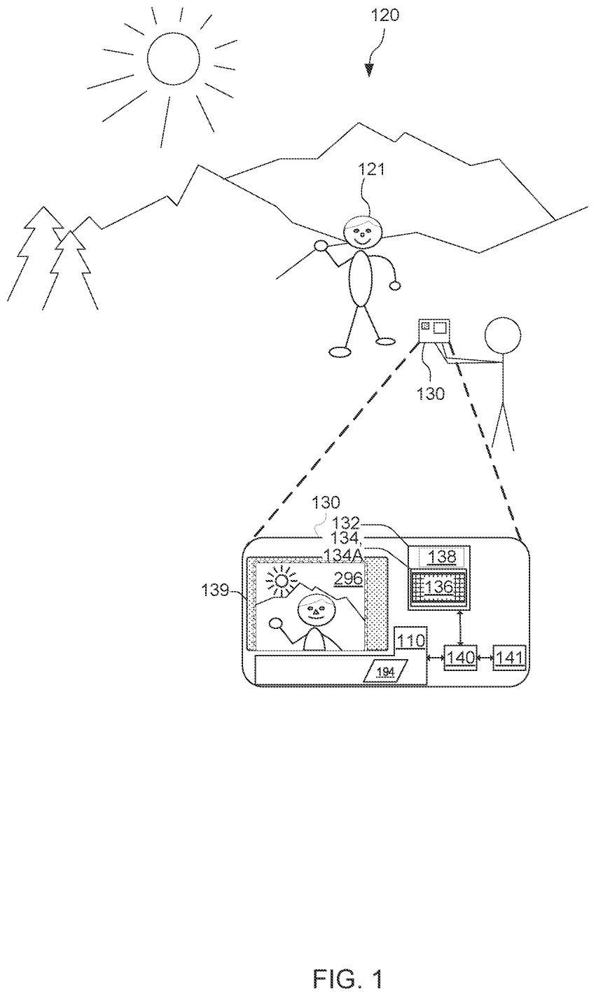

FIG. 1 depicts camera 130 imaging scene 120. Scene 120 includes a person 121. Camera 130 includes an imaging lens (not shown), image sensor 132, memory 110, and processor 140 communicatively coupled to image sensor 132. Memory 110 may be transitory and/or non-transitory and may include one or both of volatile memory (e.g., SRAM, DRAM, computational RAM, other volatile memory, or any combination thereof) and non-volatile memory (e.g., FLASH, ROM, magnetic media, optical media, other non-volatile memory, or any combination thereof). Part or all of memory 110 may be integrated into processor 140. Processor 140 may be a dedicated image signal processor or a general purpose processor (e.g., GPU, DSP, microprocessor, etc.). Image sensor 132 includes pixel array 134A, which may have color filter array (CFA) 136 thereon. Pixel array 134A includes plurality of pixels 134, not shown in FIG. 1 for clarity of illustration. Each color filter of CFA 136 is aligned with a respective pixel 134 of pixel array 134A. The imaging lens images scene 120 onto image sensor 132. Image sensor 132 also includes circuitry 138 that includes at least one analog-to-digital converter.

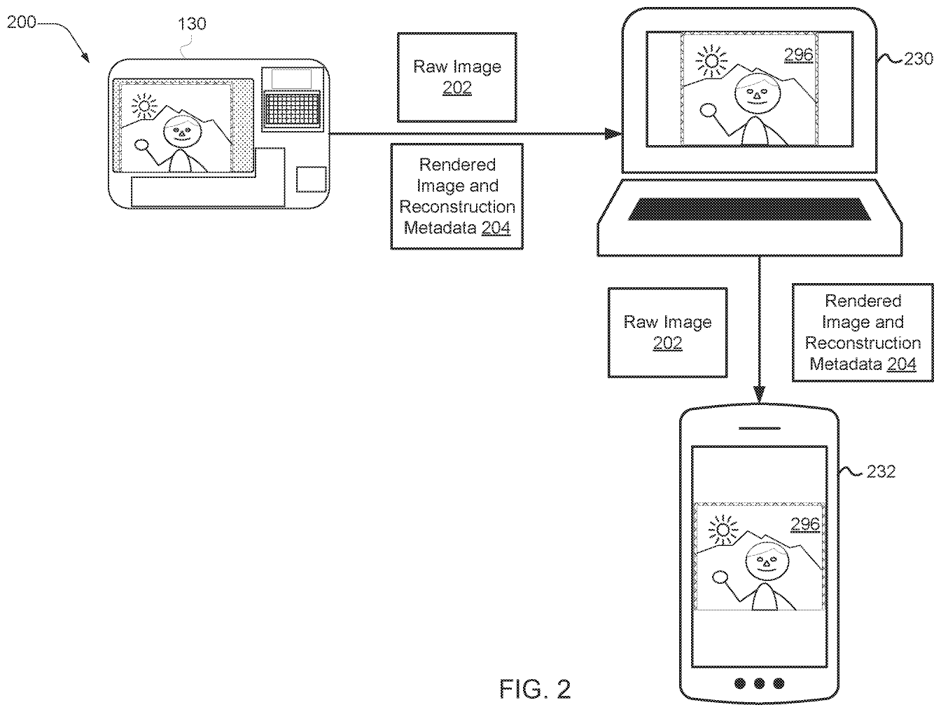

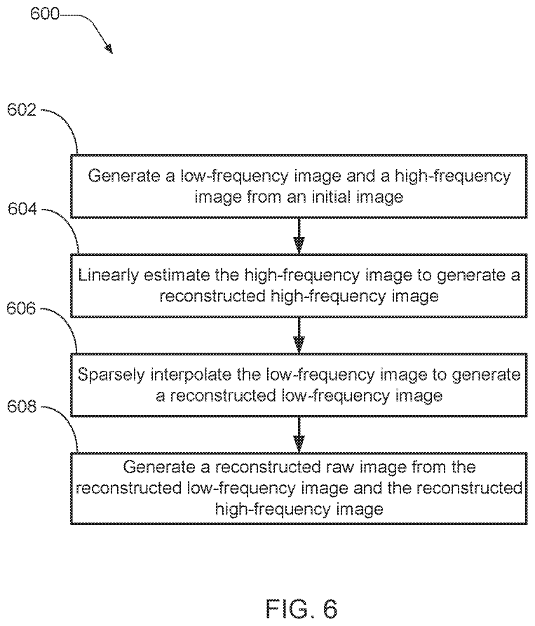

Each pixel has a respective pixel charge corresponding to a respective intensity of light from scene 120 imaged onto pixel array 134A. Circuitry 138 converts each pixel charge to a respective one of a plurality of pixel values 194 (e.g., raw image 202, with reference to FIG. 2), which are stored in memory 110. Camera 130 may include a display 139 configured to display pixel values 194 (e.g., rendered image 204) as first captured image 296. Display 139 may display pixel values 194 as a live preview. To generate rendered image 204, processor 140 may perform a series of operations on the raw image, according to instructions stored in memory 110 (discussed further in FIG. 6). Further, processor 140 generates reconstruction metadata (e.g., sub-sampled data, reconstruction matrix, dynamic range compression (DRC) parameters, and decomposition parameters) used to generate rendered image 204, and for reconstructing raw image from the rendered image, as discussed below. An ISP may generate the rendered image 141. Generating the rendered image, reconstruction metadata, as well as reconstructing the raw image is discussed below.

FIG. 2 is a flow diagram 200 illustrating camera 130 transmitting raw image, and/or rendered image and reconstruction metadata to other electronic devices. Camera 130 may transmit either raw image 202 and/or the rendered image and reconstruction metadata 204 to another electronic device 230 (e.g., a laptop, desktop, and so on). Laptop 230 may use raw image 202 to produce the rendered image and the reconstruction metadata 204. For example, a user of laptop 230 edits raw image 202 to produce an aesthetically pleasing rendered image. Alternatively, laptop 230 user wants to alter the rendered image and, because there were non-linear operations performed to produce the rendered image, altering the image may require reconstructing raw image 202 to begin anew. Further, laptop 230 may transmit raw image 202 (or reconstructed raw image) or a rendered image and reconstruction metadata 204 to yet another electronic device 232. Likewise, electronic device 232 may use raw image 202 to produce a rendered image, the reconstructed raw image to produce another rendered image, or reconstruct a raw image using the rendered image and reconstruction metadata 204.

FIG. 2 is meant for illustrative purposes and not meant to limit the present embodiments. For example, camera 130 may transmit the raw image 202 and rendered image and reconstruction metadata to any device, including electronic device 232.

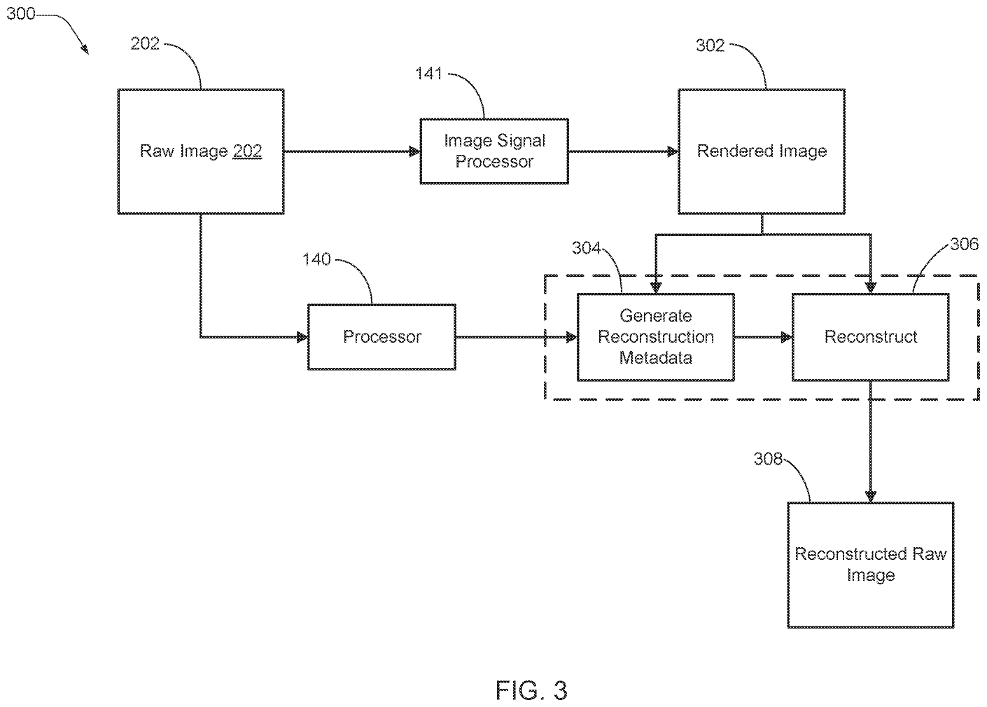

FIG. 3 is a flow diagram 300 illustrating a process of rendering an image from raw image, generating reconstruction metadata, and using the rendered image and reconstruction metadata to produce reconstructed raw image. Reconstructing raw image 202 requires reconstruction metadata (e.g., reconstruction metadata 204) that may be generated by camera 130 (e.g., ISP 141) or in an image editing tool (not shown), where there may be both raw image 202 and rendered image 302 (e.g., JPEG, sRGB image, etc.). Raw image 202 is processed, e.g., by ISP 141, to generate rendered image 302. Processing raw image 202 comprises several steps (discussed below), and each step may result in generating, and then storing, reconstruction metadata 304. Processor 140 (e.g., a GPU, CPU, etc.) may generate reconstruction metadata 304. Generated reconstruction metadata 304 and rendered image 302 are used to reconstruct 306 raw image 202, resulting in reconstructed raw image 308. Each step may be performed within a single electronic device, such as camera 130, or multiple electronic devices, as depicted in FIG. 2.

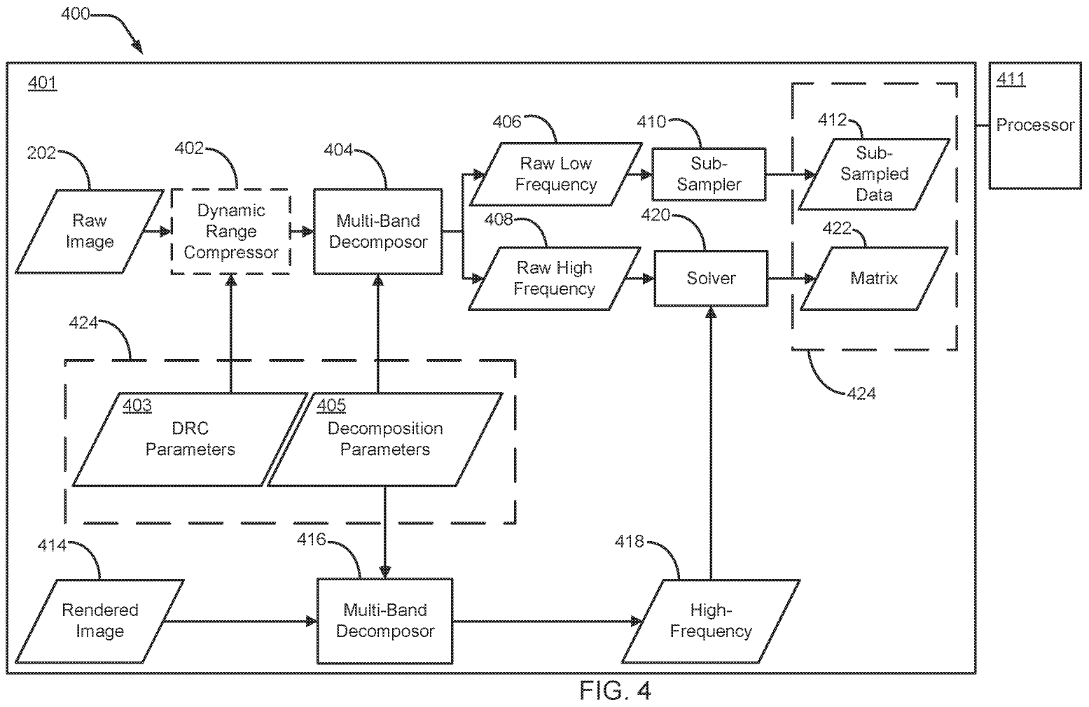

FIG. 4 is a schematic block diagram of a reconstruction metadata generator 400 that generates an image-reconstruction metadata set. Reconstruction metadata generator 400 may be part of camera 130. In embodiments, the image-reconstruction metadata set is generated by a processor 411 (e.g., processor 140, ISP 141, or some combination thereof) executing machine-readable instructions stored in a memory 401 (e.g., memory 110). Memory 401 may be transitory and/or non-transitory and may include one or both of volatile memory (e.g., SRAM, DRAM, computational RAM, other volatile memory, or any combination thereof) and non-volatile memory (e.g., FLASH, ROM, magnetic media, optical media, other non-volatile memory, or any combination thereof). Memory 401 stores machine-readable instructions as software, which may be, or include, firmware. The software includes a dynamic range compressor 402, a multi-band decomposer 404, a sub-sampler 410, a solver 420, and a multi-band decomposer 416. Processor 411 may execute the software to perform the following operations discussed in FIG. 4.

Raw image 202 is processed by dynamic range compressor 402 applying DRC to raw image 202 to reduce the dynamic range of raw image 202. In embodiments, dynamic range compressor 402 applies DRC according to DRC parameters 403. Dynamic range compressor 402 may be implemented by a gamma function, such as

$${RGB}^{′} = {RGB}^{γ} , 0 < γ \leq 1 \qquad ( 1 )$$

where RGB^{γ} is the output from DRC 402. In embodiments, a look-up-table (LUT) may be used to implement any form of non-decreasing monotonical DRC function, such as

$${RGB}^{′} - LUT ( RGB ) \qquad ( 2 )$$

where LUT (RGB) is the output from DRC 402. The resultant image signal is then decomposed at multi-band decomposer 404 into multiple frequency sub-bands, including raw low-frequency (LF) sub-band 406 and a raw high-frequency (HF) sub-band 408, represented as

$${RGB}^{′} = LF + HF \qquad ( 3 )$$

where LF is LF sub-band 406 and HF is HF sub-band 408. In embodiments, multi-band decomposer 404 uses a low pass filter (LPF) to decompose the image to raw LF sub-band 406 and raw HF sub-band 408, such as

$$LF = LPF ( {RGB}^{′} ) \qquad ( 4 )$$

$$HF = {RGB}^{′} - LPF ( {RGB}^{′} ) \qquad ( 5 )$$

Both DRC parameters 403 and decomposition parameters 405 are referred to herein as reconstruction metadata (e.g., reconstruction metadata 424), stored in memory (e.g., memory 110, 401, 501), and used to reconstruct the raw image (e.g., raw image 202) from rendered image 414 (e.g., which may be in a compressed or uncompressed file format).

Sub-sampler 410 sparsely sub-samples raw LF sub-band 406 to generate sub-sampled data 412. Sub-sampled data 412 may be either evenly spaced or un-evenly spaced. The size of sub-sampled data 412 (e.g., reconstruction metadata 424) may be further reduced by optional lossless compression (not shown). The sub-sampled data may be represented by the equation

$$D = LF ( {R}_{s} , {G}_{s} , {B}_{s} , {x}_{s} , {y}_{s} ) . \qquad ( 6 )$$

where D is sub-sampled data 412, s stands for the sparse sub-sampling points, and Rₛ, Gₛ, Bₛ, xₛ, yₛ are corresponding R/G/B values and x, y coordinates, respectively. Sparse sub-sampled data 412 is herein referred to as reconstruction metadata and may be stored in memory (e.g., memory 110, 424).

Multi-band decomposer 416 decomposes rendered image 414 to generate multiple sub-bands, including high-frequency sub-band 418, using decomposition parameters 405. High-frequency sub-band 418 and raw high-frequency sub-band 408 are used to generate reconstruction matrix 422 (as shown by equation (7)) by a solver 420 using linear estimation techniques known in the art. Reconstruction matrix 422 is represented as a 3×3 linear matrix, resulting from equation (7).

$$HF ( R , G , B ) = M * sHF ( R , G , B ) \qquad ( 7 )$$

where M is reconstruction matrix 422 and sHF(R, G, B) is HF sub-band 418. Reconstruction matrix 422 may be stored in memory (e.g., stored with sub-sampled data 412 as reconstruction metadata 424 in memory 401).

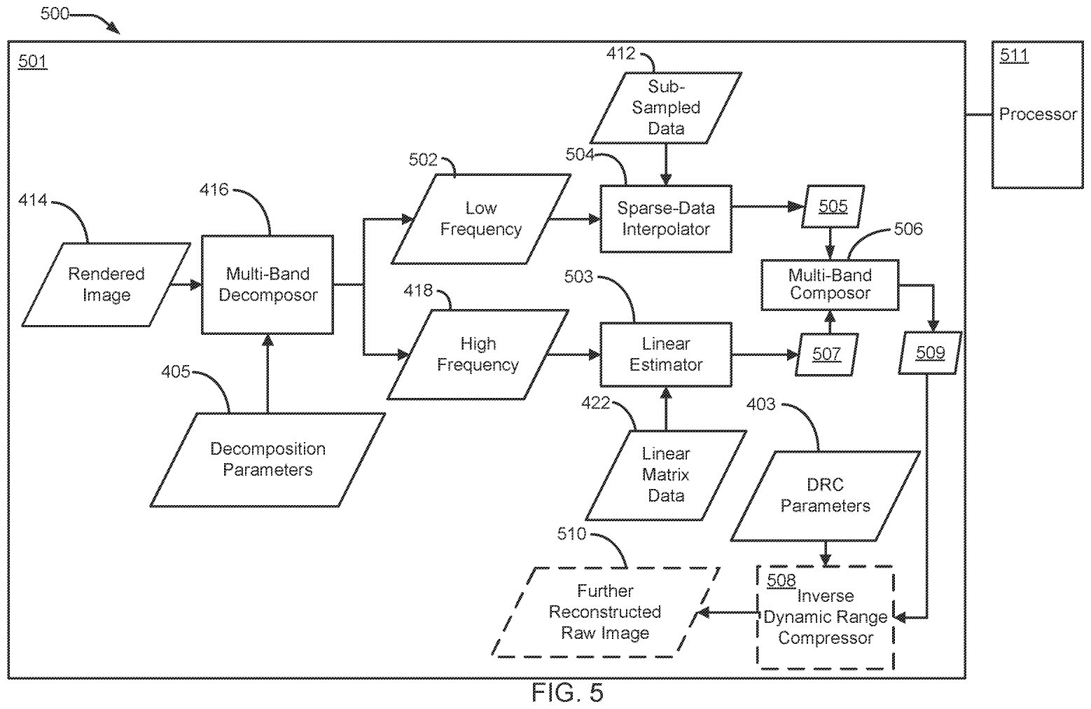

FIG. 5 is a schematic of a raw image-data reconstructor 500 that reconstructs a raw image from a rendered image using reconstruction metadata. This system may be implemented within one or more aspects of camera 130. In embodiments, the reconstructed raw image is generated by processor 511 (e.g., processor 140, ISP 141, or some combination thereof) executing machine-readable instructions stored in memory 501 (memory 110). Memory 501 may be transitory and/or non-transitory and may include one or both of volatile memory (e.g., SRAM, DRAM, computational RAM, other volatile memory, or any combination thereof) and non-volatile memory (e.g., FLASH, ROM, magnetic media, optical media, other non-volatile memory, or any combination thereof). Memory 501 stores machine-readable instructions as software, which may be, or include, firmware. The software includes an inverse dynamic range compressor 508, multi-band decomposer 416, a sparse-data interpolator 504, linear estimator 503, and a multi-band decomposer 506 to perform the following operations discussed in FIG. 5.

A raw image (e.g., raw image 202) is reconstructed using reconstruction metadata (i.e., DRC parameters 403, decomposition parameters 405, sub-sampled data 412, and reconstruction matrix 422) and rendered image 414 (e.g., JPEG sRGB image) to generate reconstructed raw image 509. Multi-band decomposer 416 decomposes rendered image 414 into multiple sub-bands, including HF sub-band 418 and LF sub-band 502. Decomposing the rendered image into sub-bands 418, 502 is according to stored decomposition parameters 405. Sparse-data interpolator 504 sparsely interpolates (e.g., via radial basis function interpolation) LF sub-band 502 to generate a reconstructed LF sub-band 505 using stored sub-sampled data 412, represented as

$$rLF ( R , G , B , x , y ) = SparseInterp ( LF ( {R}_{s} , {G}_{s} , {B}_{s} , {x}_{s} , {y}_{s} ) , sLF ( R , G , B , x , y ) ) . \qquad ( 8 )$$

where rLF(R, G, B, x, y) is reconstructed LF sub-band 505, LF (Rₛ, Gₛ, Bₛ, xₛ, yₛ) is sub-sampled data 412, and sLF(R, G, B, x, y) is LF sub-band 502. Linear estimator 503 linearly estimates HF sub-band 418 to generate a reconstructed HF sub-band 507 using reconstruction matrix 422 and raw HF sub-band 408, according to equation (9).

$$rHF ( R , G , B ) = M * sHF ( R , G , B ) \qquad ( 9 )$$

Multi-band composer 506 composes reconstructed LF sub-band 505 and reconstructed HF sub-band 507 to generate reconstructed raw image 509, according to

$$rRGB = rLF + rHF , \qquad ( 10 )$$

where rRGB is reconstructed raw image 509, rLF is reconstructed LF sub-band 505, and rHF is reconstructed HF sub-band 507. As illustrated in FIG. 4, dynamic range compressor 402 may apply DRC to raw image 202 to generate raw LF and HF frequency sub-bands 406, 408 using DRC parameters 403. To generate a further reconstructed raw image 510 in the original camera raw-RGB domain, inverse dynamic range compressor 508 applies inverse DRC to reconstructed raw image 509 (e.g., using a gamma function or a LUT) to generate further reconstructed raw image 510. Applying inverse DRC is according to the DRC parameters 403, from FIG. 4. For example, further reconstructed raw image 510 may then be obtained by one of equations (11) and (12),

$${rRGB}^{′} = {rRGB}^{\frac{1}{γ}} \qquad ( 11 )$$

$${rRGB}^{′} = {LUT}^{- 1} ( rRGB ) \qquad ( 12 )$$

where rRGB′ is further reconstructed raw image 510.

In embodiments, the operations outlined in FIGS. 4 and 5 may be performed using more than one electronic device. For example, generating the rendered image and reconstruction metadata is performed on a first device (e.g., camera 130) and reconstructing the raw image may be performed on a second device (e.g., laptop 230). For example, camera 130 may generate rendered image 414 and store reconstruction metadata 424 (i.e., DRC parameters 403, decomposition parameters 405, sub-sampled data 412, reconstruction matrix 422, and raw high-frequency sub-band 408). Reconstruction metadata 424 may then be transmitted to laptop 230 for use in generating reconstructed raw image 509 and, in embodiments, further reconstructed raw image 510.

FIG. 6 is a flowchart illustrating a method 600 for reconstructing raw image. Method 600 may be implemented within one or more aspects of raw image-data reconstructor 500. In embodiments, method 600 is implemented by processor 511 executing computer-readable instructions stored in memory 501.

Step 602 includes generating a low-frequency image (e.g., low-frequency sub-band 502) and a high-frequency image (e.g., high-frequency sub-band 418) from an initial image (e.g., rendered image 414), which is in a file format that may be compressed or uncompressed. In one example of step 602, multi-band decomposer 416 decomposes rendered image 414 according to decomposition parameters 405 to yield images 418 and 502. In one example of step 602, generating the low-frequency image and the high-frequency image further comprises decomposing the initial image using a low-pass filter. Step 604 includes linearly estimating the HF image to generate a reconstructed HF image 522. In one example of step 604, solver 420 multiplies high-frequency image 418 by reconstruction matrix 422.

Step 606 includes sparsely interpolating the LF image to generate a reconstructed LF image. In one example of step 606, sparse-data interpolator 504 sparsely interpolates LF image 502 according to sparse sub-sampled data 412 to yield a reconstructed LF image 505. Step 608 includes generating a reconstructed raw image from the reconstructed LF image and the reconstructed HF image. In one example of step 608, multi-band composer 506 composes reconstructed LF image 505 and reconstructed HF image 507 to generate reconstructed raw image 509.

In embodiments, method 600 may include additional or alternative steps, including applying dynamic range compression to a raw image to generate an encoded raw image using dynamic range compression (DRC) parameters, the initial image having been derived from the raw image. For example, dynamic range compressor 402 applies DRC to raw image 202 to generate the encoded raw image, which is received by multi-band decomposer 404. In such embodiments, method 600 may include a step 610, which includes applying inverse DRC to the reconstructed raw image to generate a reconstructed raw image. In an example of step 610, an inverse dynamic range compressor 508 applies inverse DRC to reconstructed raw image 509 to generate further reconstructed raw image 510 according to DRC parameters (e.g., DRC parameters 403). In embodiments, method 600 may further include demosaicing raw image 202 to yield initial image 414.

Method 600 may further include generating a raw low-frequency image and a raw high-frequency image from the encoded raw image using decomposition parameter and further include subsampling the raw low-frequency image to generate sub-sampled data. For example, sub-sampler 410 sub-samples raw low frequency 406 to generate sub-sampled data 412.

Method 600 may further include generating raw low-frequency image 406 from raw image 202 and sub-sampling the raw low-frequency image 406 to generate sub-sampled data 412. In an example of step 606, sparsely interpolating comprises sparsely interpolating the raw low-frequency image 406 according to the sub-sampled data 412.

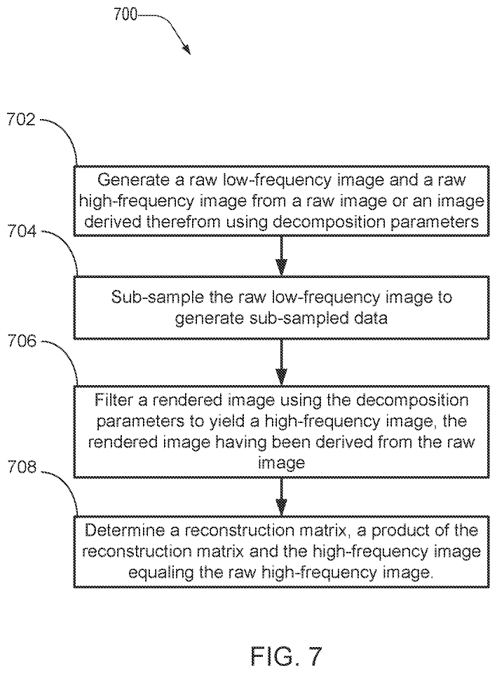

FIG. 7 is a flowchart illustrating a method 700 for generating an image-reconstruction metadata set. Method 700 may be implemented within one or more aspects of reconstruction metadata generator 400. In embodiments, method 700 is implemented by processor 411 executing computer-readable instructions stored in memory 401. Step 702 includes generating a raw low-frequency image and a raw high-frequency image from a raw image or an image derived therefrom using decomposition parameters. In one example of step 702, multi-band decomposer 404 decomposes raw image 202 (or an image derived therefrom) to generate raw low-frequency image 406 and raw high-frequency image 408 according to decomposition parameters 405. In one example of step 702, multi-band decomposer 404 uses a low-pass filter, as shown in equation (4).

Step 704 includes sub-sampling the raw low-frequency image to generate sub-sampled data. In one example of step 704, sub-sampler 410 sparsely sub-samples raw low-frequency image 406 to generate sub-sampled data 412. Sub-sampled data 412 may be stored in memory, e.g., memory 110, 401 as reconstruction metadata 424. Step 706 includes filtering a rendered image using the decomposition parameters to yield a high-frequency image. The rendered image is derived from the raw image or the image derived therefrom. In one example of step 706, multi-band decomposer 416 filters rendered image 414 to yield high-frequency sub-band 418.

Step 708 includes determining a reconstruction matrix, wherein a product of the reconstruction matrix and the high-frequency image equals the raw high-frequency image. In one example of step 708, solver 420 determines reconstruction matrix 422, where reconstruction matrix 422 is represented as a 3× 3 linear matrix, resulting from equation (7), as discussed above. The product of the reconstruction matrix 422 and high-frequency image 418 equals raw high-frequency image 408.

In embodiments, before multi-band decomposer 404 decomposes the raw image 202 in step 702, method 700 may include additional steps. In a first example of an additional step, dynamic range compressor 402 applies dynamic range compression (DRC) to raw image 202 (which may be captured by image sensor 132) to generate an encoded raw image (i.e., the image derived therefrom) using DRC parameters 403. In this example, the DRC parameters are stored in memory (e.g., memory 110, 401, stored as reconstruction metadata 424). In a second example, dynamic range compressor 402 applies DRC, using a gamma function, as shown by equation (1), to generate an encoded raw image (i.e., the image derived therefrom). In a third example, dynamic range compressor 402 applies DRC using a look-up-table (LUT) to generate an encoded raw image (i.e., the image derived therefrom) by implementing any form of non-decreasing monotonical DRC function, as shown by equation (2). In a fourth example, applying DRC to the raw image comprises gamma encoding the raw image to generate an encoded raw image (i.e., the image derived therefrom) according to the DRC parameters.

In embodiments, method 700 may include additional or alternative steps. For example, method 700 may further include demosaicing the raw image to yield the rendered image.

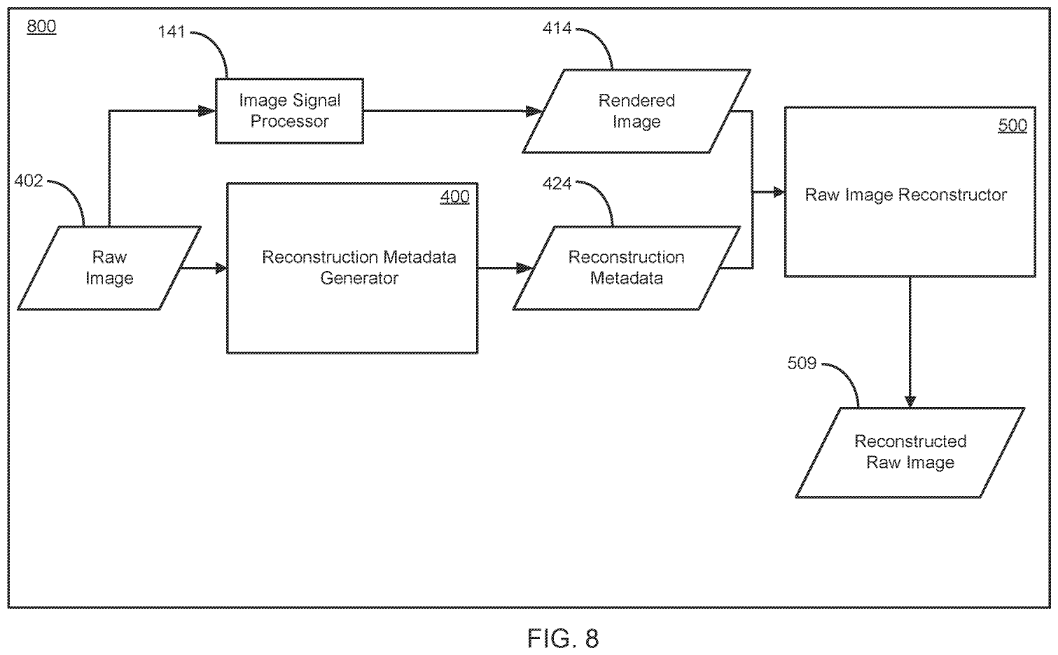

FIG. 8 is a schematic of a raw image-data reconstructor 800 that reconstructs a raw image from a rendered image and reconstruction metadata. Raw image reconstructor 800 includes reconstruction metadata generator 400 and raw image reconstructor 500 communicatively coupled thereto. Raw image reconstructor 800 may be within any device (e.g., camera 130, laptop 230, smart device 232, and so on) or multiple devices. For example, some of the operations, such as capturing raw image 202 and those performed by reconstruction metadata generator 400 (e.g., generating rendered image 414 and reconstruction metadata 424) may be performed on one device, and other operations, such as reconstructing the raw image, may be performed on another device. For example, reconstruction metadata generator 400 may be on a first device (e.g., camera 130) and raw image reconstructor 500 may be on a second device (e.g., laptop 230), or they may be on the same device.

Raw image 202 is inputted to the reconstruction metadata generator 400, which outputs reconstruction metadata 424, as discussed in the description of reconstruction metadata generator 400, FIG. 4. Further, image signal processor 141 may receive raw image 202 and output rendered image 414, as discussed in FIG. 3. The outputted rendered image 414 and reconstruction metadata 424 may then be transferred to another device, or stay within the same device, for input to the raw image reconstructor 500, where the reconstructed raw image 509 is outputted, as discussed in the description of raw image-data reconstructor 500, FIG. 5.

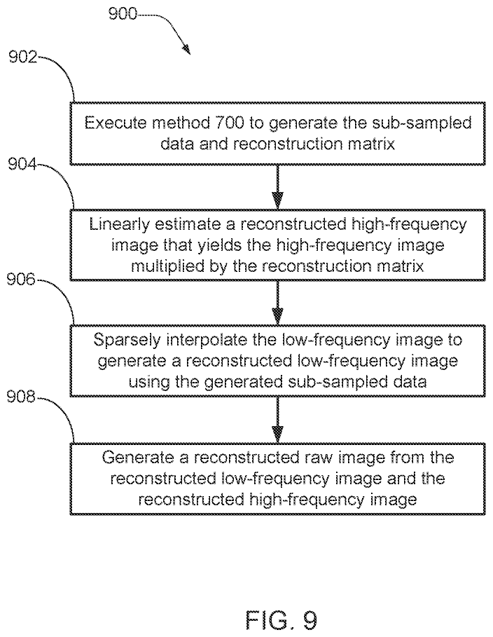

FIG. 9 is a flowchart illustrating a method 900 for reconstructing a raw image from a rendered image and reconstruction metadata. Method 900 includes steps 902-908. Step 902 may be implemented with reconstructed metadata generator 400. Steps 904-908 may be implemented with raw image reconstructor 500. In embodiments, method 900 is implemented by processor 511 executing computer-readable instructions stored in memory 501. Step 902 includes executing method 700 to generate the sub-sampled data and reconstruction matrix. Step 904 includes linearly estimating a reconstructed high-frequency image that yields the high frequency image multiplied by the reconstruction matrix. Linear estimation of step 904 may include multiplying high-frequency image 418 by reconstruction matrix 422 that, when multiplied by the high-frequency image 418, yields the raw high-frequency image 408, according to at least equation (7). In an example of step 904, linear estimator 503 linearly estimates reconstructed high-frequency sub-band 507 that yields HF sub-band 418 multiplied by reconstruction matrix 422, according to equation (9). Further, multiplying the HF sub-band 418 by the reconstruction matrix 422 yields raw HF image 408.

Step 906 includes sparsely interpolating the low-frequency image to generate a reconstructed low-frequency image using the generated sub-sampled data. In one example of step 906, sparse interpolator 504 sparsely interpolates low-frequency image 502 to generate a reconstructed low-frequency image 505 using sub-sampled data 412. Step 908 includes generating a reconstructed raw image from the reconstructed low-frequency image and the reconstructed high-frequency image. In a first example of step 908, multi-band composer 506 generates a reconstructed raw image 509 from reconstructed low-frequency image 505 and reconstructed high-frequency image 507. In a second example of step 908, generating comprises composing reconstructed low-frequency image 505 and the reconstructed high-frequency image 507.

Method 900 may include additional or alternative steps. For example, method 900 includes inversing the additional step of method 700 of dynamic range compressor 402 applying dynamic range DRC to raw image 202. The additional step of method 900 includes inversing dynamic range compression of the reconstructed raw image to generate a reconstructed raw image using the DRC parameters. In a first example, inverse dynamic range compressor 508 applies inverse dynamic range compression to the reconstructed raw image 509 to generate further reconstructed raw image 510 using DRC parameters 403. In a second example, the DRC parameters include an encoding gamma, and inversing DRC of reconstructed raw image 509 further includes applying an inverse gamma correction using the encoding gamma. In a third example, the DRC parameters include a look-up table, and inversing DRC of the reconstructed raw image further includes using the look-up-table. In a fourth example, applying inverse DRC to reconstructed raw image 509 comprises gamma encoding reconstructed raw image 509 according to the DRC parameters.

Changes may be made in the above methods and systems without departing from the scope hereof. It should thus be noted that the matter contained in the above description or shown in the accompanying drawings should be interpreted as illustrative and not in a limiting sense. The following claims are intended to cover all generic and specific features described herein, as well as all statements of the scope of the present method and system, which, as a matter of language, might be said to fall therebetween.

### Combination of Features

Features described above as well as those claimed below may be combined in various ways without departing from the scope hereof. The following enumerated examples illustrate some possible, non-limiting combinations:

(A1) A method for reconstructing a raw image, including generating a low-frequency image and a high-frequency image from an initial image; linearly estimating the high-frequency image to generate a reconstructed high-frequency image; sparsely interpolating the low-frequency image to generate a reconstructed low-frequency image; and generating a reconstructed raw image from the reconstructed low-frequency image and the reconstructed high-frequency image.

(A2) In the embodiment denoted by (A1), further including applying dynamic range compression to the raw image to generate an encoded raw image using dynamic range compression (DRC) parameters, the initial image having been derived from the raw image; and inversing the DRC of the reconstructed raw image to generate a further reconstructed raw image.

(A3) In the embodiments denoted by either (A1) or (A2), further including generating a raw low-frequency image and a raw high-frequency image from the encoded raw image using decomposition parameters, wherein linearly estimating includes multiplying the high-frequency image by a reconstruction matrix that, when multiplied by the high-frequency image, yields the raw high-frequency image; and subsampling the raw low-frequency image to generate sub-sampled data.

(A4) In any of the embodiments denoted by any one of (A1)-(A3), further comprising demosaicing the raw image to yield the initial image.

(A5) In any of the embodiments denoted by any one of (A1)-(A4), wherein said inversing dynamic range compression comprises using the DRC parameters.

(A6) In any of the embodiments denoted by any one of (A1)-(A5), wherein said generating the low-frequency image and the high-frequency image from the initial image comprises using the decomposition parameters.

(A7) In any of the embodiments denoted by any one of (A1)-(A6), wherein said sparsely interpolating comprises sparsely interpolating the low-frequency image according to the sub-sampled data.

(A8) In any of the embodiments denoted by any one of (A1)-(A7), wherein generating the low-frequency image and the high-frequency image further comprises decomposing the initial image using a low-pass filter according to the decomposition parameters.

(A9) In any of the embodiments denoted by any one of (A1)-(A8), further including generating a raw low-frequency image from a raw image; and sub-sampling the raw low-frequency image to generate sub-sampled image data. Sparsely interpolating comprises sparsely interpolating the low-frequency image according to the sub-sampled image data.

(B1) A method for generating an image-reconstruction metadata set, including generating a raw low-frequency image and a raw high-frequency image from a raw image or an image derived therefrom using decomposition parameters; subsampling the raw low-frequency image to generate sub-sampled data; filtering a rendered image using the decomposition parameters to yield a high-frequency image, the rendered image having been derived from the raw image; determining a reconstruction matrix, a product of the reconstruction matrix, and the high-frequency image equaling the raw high-frequency image.

(B2) In the embodiment denoted by (B1), further including demosaicing the raw image to yield the rendered image.

(B3) In the embodiments denoted by either (B1) or (B2), further including applying dynamic range compression (DRC) to the raw image to derive an encoded raw image using DRC parameters, said step of generating including generating the raw low-frequency image and the raw high-frequency image from the encoded raw image.

(B4) In any of the embodiments denoted by any one of (B1)-(B3), wherein applying DRC to the raw image comprises gamma encoding the raw image according to the DRC parameters.

(B5) In any of the embodiments denoted by any one of (B1)-(B4), applying DRC to the raw image comprises using a look-up-table, and applying the dynamic range compression to the raw image comprises using the look-up-table.

(B6) In any of the embodiments denoted by any one of (B1)-(B5), further including determining the reconstruction matrix as a matrix that, when multiplied by the high-frequency image yields the raw high-frequency image.

(C1) A method for reconstructing an image, including generating sub-sampled data and reconstruction matrix by generating a raw low-frequency image and a raw high-frequency image from a raw image or an image derived therefrom using decomposition parameters, subsampling the raw low-frequency image to generate sub-sampled data, and filtering a rendered image using the decomposition parameters to yield a high-frequency image, the rendered image having been derived from the raw image; and determining a reconstruction matrix, wherein a product of the reconstruction matrix and the high-frequency image equals the raw high-frequency image; sparsely interpolating a low-frequency image to generate a reconstructed low-frequency image using the sub-sampled data; linearly estimating the raw high-frequency image that yields the high-frequency image multiplied by a reconstruction matrix; and generating a reconstructed raw image from the reconstructed low-frequency image and the reconstructed high-frequency image.

(C2) In the embodiment denoted by (C1), further including inversing dynamic range compression of the reconstructed raw image to generate a reconstructed raw image using the DRC parameters.

(C3) In the embodiments denoted by either (C1) or (C2), where the DRC parameters include an encoding gamma, inversing dynamic range compression of the reconstructed raw image further comprises applying an inverse gamma correction using the encoding gamma.

(C4) In the embodiments denoted by any one of (C1)-(C3), where the DRC parameters include a look-up table, and inversing dynamic range compression of the reconstructed raw image further comprises using the look-up-table.

(D1) A system including: a processor; a memory communicatively coupled with the processor and storing machine-readable instructions that, when executed by the processor, cause the processor to implement any one of methods (A1)-(A9), (B1)-(B6), and (C1)-(C4).

1. A method for generating an image-reconstruction metadata set from a raw image or an image derived therefrom and from a rendered image derived from the raw image, comprising:
generating a raw low-frequency image and a raw high-frequency image from the raw image or the image derived therefrom using decomposition parameters;
subsampling the raw low-frequency image to generate sub-sampled data;
filtering the rendered image using the decomposition parameters to yield a high-frequency image; and
determining a reconstruction matrix, wherein a product of the reconstruction matrix and the high-frequency image equals the raw high-frequency image.

2. The method of claim 1, further comprising:
applying dynamic range compression, DRC, to the raw image to derive an encoded raw image using DRC parameters,
said step of generating including generating the raw low-frequency image and the raw high-frequency image from the encoded raw image.

3. The method of claim 2, wherein applying DRC to the raw image comprises gamma encoding the raw image according to the DRC parameters.

4. The method of claim 2, wherein applying DRC to the raw image comprises using a look-up-table, and applying the dynamic range compression to the raw image comprises using the look-up-table.

5. A method for reconstructing a raw image from a rendered image that is derived from the raw image, comprising:
receiving sub-sampled data and a reconstruction matrix, wherein the sub-sampled data represent a sub-sampled raw low-frequency image generated from the raw image, and wherein the reconstruction matrix is determined such that a product of the reconstruction matrix and a high-frequency image generated from the rendered image equals a raw high-frequency image generated from the raw image;
sparsely interpolating a low-frequency image generated from the rendered image to generate a reconstructed raw low-frequency image using the sub-sampled data;
generating a reconstructed raw high-frequency image as a product of a high-frequency image generated from the rendered image and the reconstruction matrix; and
generating a reconstructed raw image from the reconstructed raw low-frequency image and the reconstructed raw high-frequency image.

6. The method of claim 5, wherein the low-frequency image and the high-frequency image are generated by decomposing the rendered image using a low-pass filter according to decomposition parameters.

7. The method of claim 5, further comprising inversing dynamic range compression of the reconstructed raw image to generate a further reconstructed raw image using DRC parameters.

8. A system comprising:
a processor;
a memory communicatively coupled with the processor and storing machine-readable instructions that, when executed by the processor, cause the processor to perform the method of claim 1.
